(19) United States
(12) Patent Application Publication
(10) Pub. No.: US 2003/0112277 A1
(43) Pub. Date: Jun. 19, 2003

(54) Input of data using a combination of data input systems

(75) Inventor: Yevgeniy Eugene Shteyn, Cupertino, CA (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 10/022,754

(22) Filed: Dec. 14, 2001

(51) Int. Cl. G09G 5/00

(52) U.S. Cl. 345/773

(57) ABSTRACT

A device is provided with two complementary input systems. One of the two input systems is ambiguous in the senses that it associates a first given user input with more than one potential data. The device cannot recognize from this first input system which actual data is sought by the user. To resolve the plurality of potential data the user provides a second user input through the second input system. From the second user input, a processing unit is capable of identifying from the plurality of potential data, the one actually sought by the user.

### FIELD OF THE INVENTION

The invention relates to a device equipped with a display and a plurality of data input systems. The invention relates to any sort of personal consumer appliances into which users can input data.

### BACKGROUND ART

Manufacturers of consumer electronics and communication devices such as cell-phones, personal digital assistants, Web-pads, instant messengers or remote controls tend to limit the real estate of such devices dedicated to the input of data. As the size of theses devices is reduced, real keyboards for example become smaller or get replaced by virtual keyboards. That, in turn, leads to very small individual real or virtual letter keys. Individuals may have difficulties to pick the right symbol on such keyboards without using a special tool, e.g. a stylus. Spelling errors, ambiguous data input and slow data entering may also result therefrom. To remedy these drawbacks, various solutions have been contemplated. Some proposed solutions consist of developing other data input systems such as voice recognition input systems, handwriting recognition input systems or stylus-aided input systems. Other existing solutions consist in combining various data input systems and comparing the results of two or more of these input systems to determine the entered data.

U.S. Pat. No. 6,285,785, incorporated herein by reference, discloses a method of, and apparatus for, operating an automatic message recognition system. The described method and apparatus employ an integrated use of speech and handwriting recognition to improve an overall accuracy, in terms of throughput, of an automatic recognizer. The user's speech is converted to a first signal and the user's handwriting is converted to a second signal. The first and second signals are processed to decode a consistent message, conveyed separately by the first signal and the second signal, or conveyed jointly by the first signal and the second signal.

In some instances, the real or virtual keyboards are purposely reduced to comprise fewer keys than conventional AZERTY OR QWERTY keypads where a specific keystroke corresponds to one letter, number or graphical symbol only. For example, in the telecommunication field, methods of name selection are known which use a numeric keypad. The telephone keypad has numerals as well as letters associated with the keys. For example, the key “2” is also associated with the letters A, B and C. It is known in some dialing systems to dial a person's number by entering the person's name. The first few letters are often enough to identify the person by comparison with a finite list of names. On this subject, reference is made to U.S. Pat. No. 5,952,942, incorporated herein by reference. This document describes a method of text entry into a device by activating keys of a keypad, where a key represents various characters. A dictionary is searched for candidate combinations of characters corresponding to the keys activated. The candidate combinations are rank ordered. Feedback is provided to a user indicating at least a highest rank ordered candidate combination. The provided feedback is such to have a likelihood of corresponding to the user input. The likelihood may be determined based on a language model, i.e. likelihood of usage in a given language.

Reference is also made to U.S. Pat. Nos. 6,307,548 and 6,307,549. These documents describe a reduced keyboard disambiguating system having a keyboard with a reduced number of keys. A plurality of symbols and letters are assigned to a set of data keys so that keystrokes entered by the user are ambiguous. Due to the ambiguity in each keystroke, an entered keystroke sequence could match a number of words with the same number of letters. The disambiguating system includes a memory having a number of vocabulary modules. The vocabulary modules contain a library of objects that are each associated with a keystroke sequence. Each object is also associated with a frequency of use. Object within the vocabulary modules that match the entered keystroke sequence are displayed to the user in a selection list. The objects are listed in the selection list according to their frequency of use. An unambiguous select key is pressed by a user to delimit the end of a keystroke sequence. The first entry in the selection list is automatically selected by the disambiguating system as the default interpretation of the ambiguous keystroke sequence. The user accepts the selected interpretation by starting to enter another ambiguous keystrokes sequence. Alternatively, the user may press the select key a number of times to select other entries in the selection list.

### SUMMARY

It is an object of the invention to provide a device having two complementary data input systems configured to be used in parallel. The first input system is configured to be ambiguous and any ambiguity raised by the first system is removed by the second system.

It is another object of the invention to provide a device with a fast and reliable data input system with optimized use of the input and output capabilities of the device.

It is a further object of one or more embodiments of the invention to efficiently integrate speech recognition and an ambiguous keystroke input system.

It is yet another object of one or more embodiments of the invention to efficiently integrate speech recognition and an ambiguous pointing input system.

To this end, a device of the invention comprises a first data input system configured to ambiguously associate a first user input with a plurality of potential data. The device also comprises a second input data system receiving a second user input. The device then comprises a processing unit coupled to the two input data systems, which determines a specific one of the plurality of potential data from the second user input.

The first and the second data input systems may be independent systems that an individual uses in parallel to input data to the device. The first input data system is ambiguous in the sense that it is configured to associate a user input with a plurality of potential data. The first input system as designed by the manufacturer raises ambiguity. Such an input system may be desirable in smaller devices to minimize the size of the device. As used herein potential data may indicate any type of selectable data such as displayable data such as graphical symbols, words, letters, numerals, or combination of such. Thus, an ambiguous data input system is for example a keypad with a reduced number of keys where each key is associated with several symbols. In the invention, the ambiguity is removed when the individual uses the second data input system to indicate which symbol is actually sought by the user. The second data input system is for example a speech recognition input system so that the user can spell or speak the desired symbol. Thus, when the individual presses a key associated with “Q”, “W”, “A” and “S”, the four letters are actually indicated to the device. Simultaneously the individual may say the letter “W” to indicate the desired letter. Alternately, the individual may type a full word and spell or say the word while or after typing it.

In another example, a wristwatch with an appointment scheduling system is considered. The first ambiguous input system is a substantially small touch sensitive display with an analog watch dial interface. The second input is a microphone coupled to a speech recognition system. The user is enabled to set an appointment by touching, e.g. with a finger, the display in the general area around a desired time point and substantially simultaneously stating the desired time. The scheduling system resolves the first input to a time interval and then uses the speech recognition system to set the appointment time more precisely. The speech recognition system may also be ambiguous because of, e.g. noise, limited processing power of the unit, and etc . . . In latter case, the intersection of values provided by ambiguous inputs is used to extract sufficient information to set up the desired appointment time.

### BRIEF DESCRIPTION OF THE DRAWING

The invention is explained in further details, by way of examples, and with reference to the accompanying drawing wherein:

FIG. 1 is a block diagram of a device of the invention;

FIG. 2 is a first embodiment of a device of the invention;

FIG. 3 is a second embodiment of a device of the invention; and,

FIG. 4 and FIG. 5 are snapshots of the display of a GPS device of the invention.

Elements within the drawing having similar or corresponding features are identified by like reference numerals.

### DETAILED DESCRIPTION

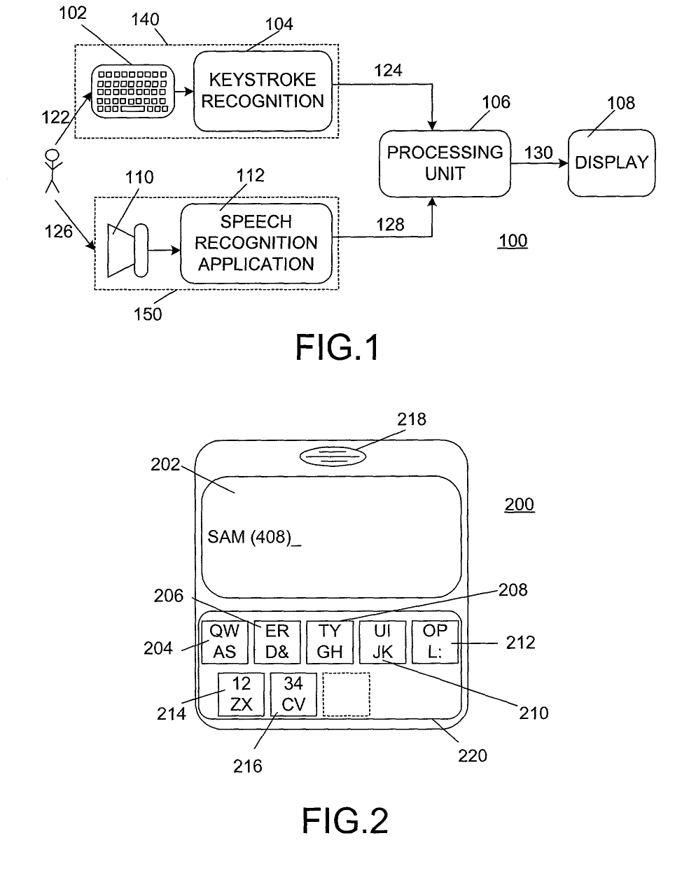

FIG. 1 is a block diagram of a device 100 of the invention. Such a device 100 comprises a first input system 140. The input system 140 is configured to be ambiguous in the sense that it associates a given user input 122 with a plurality of possible selectable data 124. The user input 122 is therefore ambiguous because the device 100 cannot determine, so far, the actual selectable data that the user sought to enter. The input system 140 comprises, for example, a keypad 102 with a reduced number of keys in comparison with a conventional keypad. A key of the keyboard 102 is associated with several selectable data. In this embodiment, a text data may be a letter, a numeral or a graphic symbol. As used herein “selectable data” may also indicate a combination of letters, numerals or symbol such as a word or a sentence. The selectable data may also be in other embodiments entries in a calendar, times in a schedule, area on a map, etc . . . The input system 102 further comprises a keystroke recognition application 104 for recognizing the user input 122 and for identifying the plurality of selectable data 124 associated with the user input 122. The association process may be done through use of a configurable lookup table associating each individual key of the keypad 102 with its respective letters, symbols or numerals. The keypad 102 may comprise real hard buttons or soft virtual buttons and the user may be able to reconfigure the association of the keys with other respective letters, numerals or symbols.

The input system 140 provides the identified plurality of selectable data 124 to a processing unit 106. At this stage, the processing unit 106 cannot determine the text data actually sought by the user. To remove the ambiguity, the device 100 further comprises a second input system 150. The second input system 150 is complementary to the first system 140.

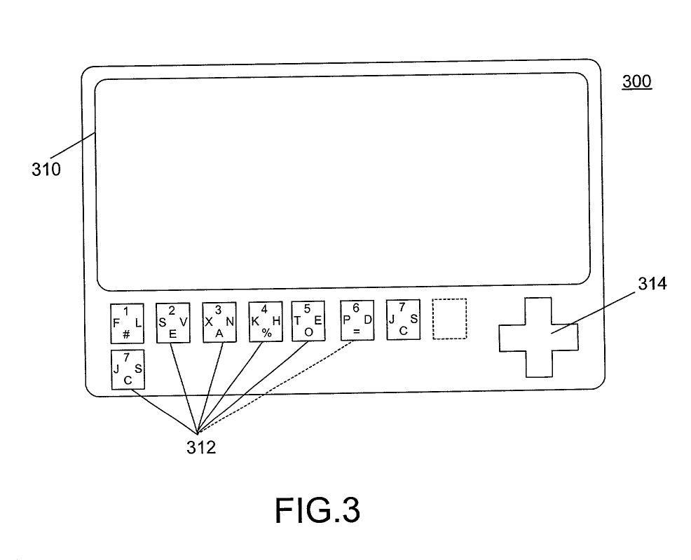

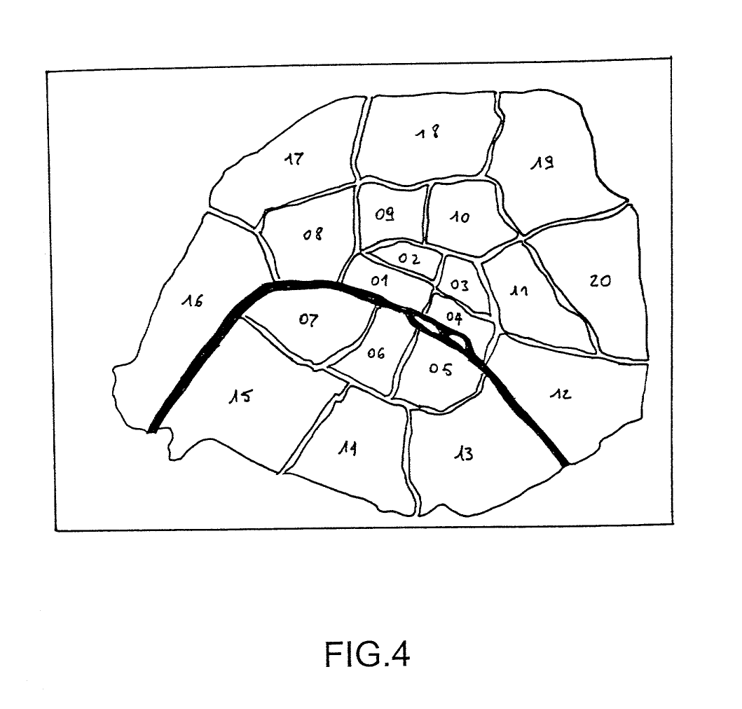

In this embodiment, the system 150 is a voice recognition input system. The system 150 comprises a microphone 110 and a speech recognition application 112 coupled to the microphone 110. In this embodiment, when the user enters a letter or symbol by pressing a key of the keypad 102, the user may speak the desired letter or symbol in the microphone 110. Alternately, upon or after typing a word the user may say or spell the word that he is currently typing or that he just typed. The system 150 processes this second user input 126 being a speech sample and provides an output data 128 to the processing unit 106. The second user input 126 enables the processing unit 106 to determine which one of the plurality of selectable data 124 was actually entered by the user. The processing unit 106 provides the determined selectable data 130 to a display 108 for display. The selected data 130 may also be stored in an internal memory of the device 100. Examples of embodiments of a device of the invention are given hereinafter with reference to FIG. 2 and FIG. 3.

FIG. 2 shows a device 200 of the invention. The device 200 is a personal consumer electronic product such as a remote control, a personal digital assistant, a cell phone or the like. The user may need the device 200, e.g., to take notes in business meetings, to send or read emails, check a personal calendar, control other consumer electronic devices or store a personal address book. The device 200 includes a display 202 and a keypad 220 comprising a plurality of individual keys 204-216. In this embodiment, the keypad 220 is implemented with hard buttons keys 204-216 however in other embodiments, the keypad 220 can be a virtual keypad with touch-selectable keys displayed onto display 202.

The device is equipped with two different input systems: a first ambiguous one and a second one. The keypad 220 belongs to the first input system. As explained previously, this first data system is designed to be ambiguous in the sense that the device 200 cannot determine a text data sought by the user using only the first input system. Each key 204-216 corresponds to four different symbols, letters or numbers. The key 206 is, for example, associated with the letters “E”, “R”, “F” and the symbol “&”. Thus, when the user presses the key 206, the first input system 220 indicates these four different text data: “E”, “R”, “F” and “&” to the device 200.

The second data input system is a voice recognition input system comprising a microphone 218. The user can spell or say a word when typing it on the keyboard 220. For example, when pressing the key 206, the user simultaneously says the letter “E” in the vicinity of the microphone 218. From the keystroke and the speech sample, the device 200 identifies the letter “E” from the four text data E, R, F and & initially indicated by the key 206 and displays the letter “E” on the display 202.

FIG. 3 is another example of a device 300 of the invention. This device 300 comprises a display 310, a keyboard 312 being part of a first ambiguous data input system and a four-direction button 314. Each key of the keyboard 312 is associated with four text data so that when the user selects a specific key, the four respective letters, numerals or symbols associated with the key are indicated to the device 300. Each key displays the four characters associated with it as shown in FIG. 3: the first one in the upper part of the key, the second one on the left, the third one on the right and the last one in the lower part of the key. The button 314 belongs to the second data input system of the device 300. The user can press the button 314 in four directions, thereby indicating which one of the four characters associated with a key he enters. For example, by pressing the key 314, the user indicates the four text data: “1”, “F”, “L” and “#” to the device 300. The user then presses the upper part of the button 314 if he wants to enter “1”, the lower part if he wants to enter “#”, the left part if he wants to enter “F” and the right part if he wants to enter the letter “L”. The two input systems are independent, however the first input system cannot be used alone when entering data into the device 100.

The keypad 312 and the button 314 can be designed so that a user holding the device 300 with both hands can press all keys of the keyboard 312 and the button 314 with his left and right thumbs, respectively.

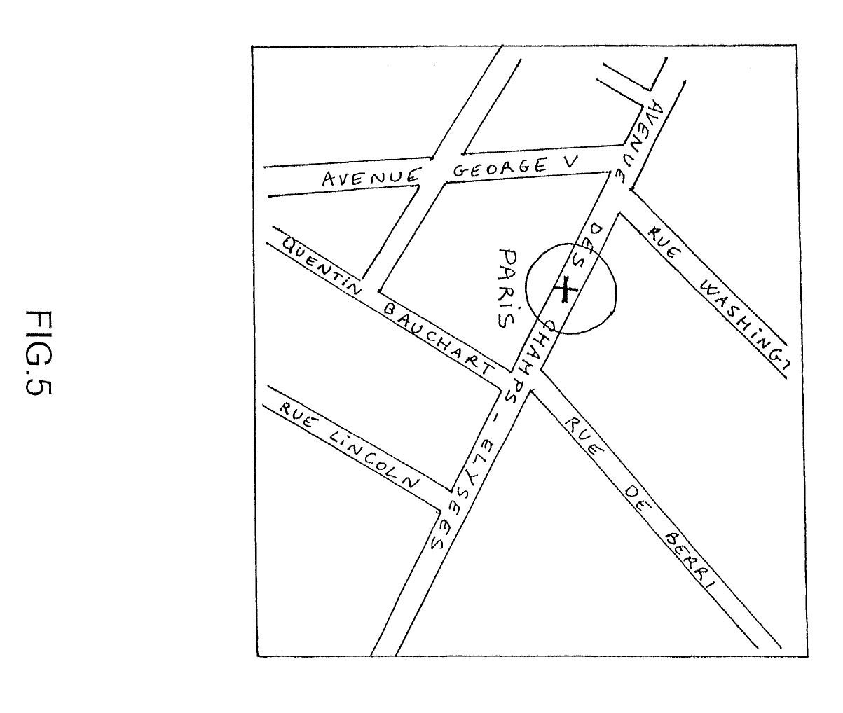

FIG. 4 and FIG. 5 refer to a third embodiment of a device of the invention. In this embodiment, the device is a GPS device providing driving directions, navigation assistance and maps. FIG. 4 and FIG. 5 are snapshots of the screen of such a device. Let's assume that an American businessman is driving a rental car to a business meeting on the “Avenue des Champs Elysees” in Paris, France. His rental car is equipped with a GPS device of the invention providing maps and driving directions within Paris. The GPS device can be controlled through a combination of voice input and a touch-sensitive screen. The businessman is lost and needs to find his way to his business meeting. He desires to know where exactly is located the “Avenue des Champs Elysees”. FIG. 3 shows the initial display of his GPS system, showing a map of Paris and its 20 arrondissements. The businessman knows approximately where the street is. With his finger, he selects on the screen the neighborhood of Paris where the avenue des Champs Elysees is, the ₈th arrondissement. Due to the small size of the screen, his finger cannot precisely select the avenue of Champs Elysees. A portion of Paris is thus selected. This portion of Paris comprises a limited number of streets and monuments. Therefore, the user input is associated with several streets or monuments corresponding to the portion of the screen selected by the businessman. Then, the businessman says the name of the street in a microphone of the GPS device of the invention. From the first screen selection and the voice input, the device can now compare the voice input and the names of the streets in the selected portion. When a match is found, the device displays to the businessman a map of the Avenue des Champs Elysees as shown in FIG. 6. The map can also indicate, e.g. traffic jams, open parking lots, gas stations or whether the street is one-way or both directions.

The touch-sensitive screen input is ambiguous since the businessman cannot pick the right street from the screen due to the limited screen size. The GPS device of the invention cannot identify the appropriate street from the first input only. The voice input permits to remove the ambiguity and refine the input data.

1. A device comprising:
an ambiguous first data input system configured to associate a first user input with a plurality of potential data;
a second data input system independent from the first data input system receiving a second user input; and,
a processing unit coupled to the first and second input systems for selecting one of the plurality of potential data from the second user input.

2. The device of claim 1, further comprising:
a display coupled to the processing unit and configured to display the selected potential data.

3. The device of claim 1, wherein the first data input system comprises a real or virtual keyboard configured to associate a specific keystroke with a plurality of graphical characters.

4. The device of claim 1, wherein the first data input system comprises a touch-sensitive screen.

5. The device of claim 1, wherein the second data input system is a speech recognition input system, a handwriting input system, a stylus input system or a keystroke input system.

6. The device of claim 1, wherein the processing unit further determines the selected data based on a dictionary database internally or remotely accessed.

7. A software application comprising instructions to perform the following steps:
associating a first user input provided by a user through a first ambiguous input system with a plurality of potential data;
receiving a second user input through a second data input system;
processing the plurality of text data and the second user input to select one of the plurality of potential data from the second user input data.
